(19) United States
(12) Patent Application Publication
(10) Pub. No.: US 2024/0340833 A1
(43) Pub. Date: Oct. 10, 2024

(54) METHOD FOR REQUESTING NETWORK SLICE, TERMINAL DEVICE, AND NETWORK DEVICE

(71) Applicant: GUANGDONG OPPO MOBILE TELECOMMUNICATIONS CORP., LTD., Dongguan, Guangdong (CN)

(72) Inventor: Haorui YANG, Dongguan (CN)

(21) Appl. No.: 18/743,076

(22) Filed: Jun. 13, 2024

Related U.S. Application Data
(63) Continuation of application No. PCT/CN2021/143118, filed on Dec. 30, 2021.

(51) Int. Cl. H04W 60/00; H04W 48/18

(52) U.S. Cl. CPC H04W 60/00; H04W 48/18

(57) ABSTRACT

A method for requesting a network slice includes the following. A terminal device obtains tracking area (TA) information corresponding to a first network slice; determines, according to the TA information, whether a current TA supports the first network slice; and initiates a registration request for the first network slice based on a determination that the current TA supports the first network slice, and/or does not initiate the registration request for the first network slice based on a determination that the current TA does not support the first network slice, where the registration request contains first single-network slice selection assistance information (S-NSSAI) identifying the first network slice.

### CROSS-REFERENCE TO RELATED APPLICATION(S)

This application is a continuation of International Application No. PCT/CN2021/143118, filed Dec. 30, 2021, the entire disclosure of which is hereby incorporated by reference.

### TECHNICAL FIELD

This disclosure relates to the field of communication technology, and in particular to a method for requesting a network slice, a terminal device, and a network device.

### BACKGROUND

In a communication system, a network slice refers to abstracting various physical resources in a network into virtual resources by using a network virtualization technology, and based on a designated network function and a specific access network technology, building an end-to-end logical network on demand, thus providing one or more network services and applications. By tailoring the network and implementing flexible network element networking, the network slice can provide an optimized network resource allocation solution.

With the development of communication technology, different tracking areas (TAs) can support different network slices. In this scenario, how to control the use of a network slice by a terminal device is a technical problem that needs to be solved urgently.

### SUMMARY

In a first aspect, embodiments of the present disclosure provide a method for requesting a network slice. The method is applicable to a terminal device and includes the following. Tracking area (TA) information corresponding to a first network slice is obtained. Whether a current TA supports the first network slice is determined according to the TA information. A registration request for the first network slice is initiated based on a determination that the current TA supports the first network slice, and/or the registration request for the first network slice is not initiated based on a determination that the current TA does not support the first network slice, where the registration request contains first single-network slice selection assistance information (S-NSSAI) identifying the first network slice.

In a second aspect, embodiments of the present disclosure provide a terminal device. The terminal device includes a processor, a memory, and a transceiver. The processor is coupled to the memory and to the transceiver. The memory is configured to store instructions. When executed by the processor, the instructions cause the terminal device to obtain TA information corresponding to a first network slice, to determine, according to the TA information, whether a current TA supports the first network slice, to initiate a registration request for the first network slice based on a determination that the current TA supports the first network slice, and/or not initiate the registration request for the first network slice based on a determination that the current TA does not support the first network slice, where the registration request contains first S-NSSAI identifying the first network slice.

In a third aspect, embodiments of the present disclosure provide a core network device. The core network device includes a processor, a memory, and a transceiver. The processor is coupled to the memory and to the transceiver. The memory is configured to store instructions. When executed by the processor, the instructions cause the core network device to transmit TA information corresponding to a first network slice to a terminal device. The TA information is used for the terminal device to determine whether a current TA supports the first network slice, and for the terminal device to initiate a registration request for the first network slice based on a determination that the current TA supports the first network slice, or not to initiate the registration request for the first network slice based on a determination that the current TA does not support the first network slice, where the registration request contains first single-network slice selection assistance information (S-NSSAI) identifying the first network slice

### BRIEF DESCRIPTION OF THE DRAWINGS

The following will give a brief introduction to the accompanying drawings used in descriptions of embodiments.

FIG. 1 is a system architecture diagram of a communication system provided in embodiments of the present disclosure;

FIG. 2 is a schematic flowchart of a method for requesting a network slice provided in embodiments of the present disclosure;

FIG. 3 is a schematic flowchart of another method for requesting a network slice provided in embodiments of the present disclosure;

FIG. 4 is a schematic flowchart of yet another method for requesting a network slice provided in embodiments of the present disclosure;

FIG. 5 is a schematic flowchart of yet another method for requesting a network slice provided in embodiments of the present disclosure;

FIG. 6 is a schematic flowchart of yet another method for requesting a network slice provided in embodiments of the present disclosure;

FIG. 7 is a schematic flowchart of yet another method for requesting a network slice provided in embodiments of the present disclosure;

FIG. 8 is a schematic structural diagram of a terminal device provided in embodiments of the present disclosure;

FIG. 9 is a schematic structural diagram of another terminal device provided in embodiments of the present disclosure;

FIG. 10 is a schematic structural diagram of a core network device provided in embodiments of the present disclosure;

FIG. 11 is a schematic structural diagram of another core network device provided in embodiments of the present disclosure;

FIG. 12 is a schematic structural diagram of an access network device provided in embodiments of the present disclosure; and

FIG. 13 is a schematic structural diagram of another access network device provided in embodiments of the present disclosure.

### DETAILED DESCRIPTION

The following will describe technical solutions of embodiments of the present disclosure with reference to the accompanying drawings.

The technical solutions of embodiments of the disclosure are applicable to various communication systems, for example, a global system of mobile communication (GSM), a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, an advanced LTE (LTE-A) system, a universal mobile telecommunication system (UMTS), a worldwide interoperability for microwave access (WiMAX) communication system, a new radio (NR) system, an evolved system of the NR system, an LTE-based access to unlicensed spectrum (LTE-U) system, an unlicensed spectrum (NR-U) system, a 5G system, a multiple-in multiple-out (MIMO) system, a wireless local area networks (WLAN), a wireless fidelity (WiFi), a next-generation communication system, or other communication systems, etc.

Generally speaking, a conventional communication system generally supports a limited quantity of connections and therefore is easy to implement. However, with the development of communication technology, a mobile communication system will not only support conventional communication but also support, for example, device-to-device (D2D) communication, machine-to-machine (M2M) communication, machine-type communication (MTC), or vehicle-to-vehicle (V2V) communication, etc. Embodiments of the disclosure can also be applicable to these communication systems.

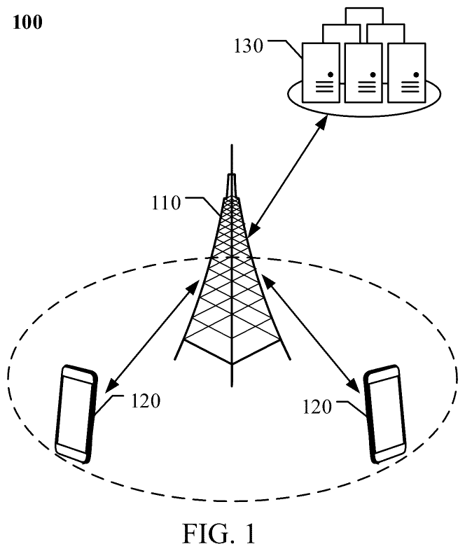

Exemplarily, FIG. 1 illustrates a communication system 100 to which embodiments of the disclosure are applicable. The communication system 100 may include an access network device 110. The access network device 110 may be a device that can communicate with a terminal device 120 (also referred to as “communication terminal” or “terminal”). The access network device 110 can provide communication coverage for a specific geographical area and communicate with terminals in the coverage area. Optionally, the access network device 110 may be an evolutional Node B (eNB or eNodeB) in an LTE system, or a radio controller in a cloud radio access network (CRAN), or the access network device may be a mobile switching center, a relay station, an access point, an in-vehicle device, a wearable device, a hub, a switch, a bridge, a router, a network-side device in a 5G network, or a access network device in a future communication system, etc.

The communication system 100 further includes at least one terminal device 120 located in the coverage area of the access network device 110. The terminal device 120 is connected to the access network device 110 through a wireless or wired connection. The terminal device may be called a “wireless communication terminal”, a “wireless terminal”, or a “mobile terminal”. Examples of a mobile terminal may include, but are not limited to, a satellite telephone or cellular telephone, a personal communication system (PCS) terminal integrated with functions of a cellular radio telephone, data processing, fax, and/or data communication, a personal digital assistant (PDA) equipped with radio telephone, pager, Internet/Intranet access, web browsing, notebook, calendar, and/or global positioning system (GPS) receiver, and a conventional laptop and/or a handheld receiver, or other electronic devices equipped with a radio telephone receiver. The terminal may refer to an access terminal, a user equipment (UE), a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a PDA, a device with wireless communication functions such as a handheld device, a computing device, other processing devices coupled with a wireless modem, an in-vehicle device, and a wearable device, a terminal in a 5G network, a terminal in the future evolved public land mobile network (PLMN), etc.

Optionally, the terminal device 120 can communicate with other terminal devices or UEs through D2D communication.

Optionally, the 5G system or 5G network can also be referred to as an NR system or NR network.

In embodiments of the present disclosure, the communication system 100 further includes a core network device 130 that communicates with the access network device 110. Optionally, the core network device 130 may be a 5G core network device, for example, an access and mobility management function (AMF) or a session management function (SMF). Optionally, the core network device 130 may also be an evolved packet core (EPC) device for an LTE network, for example, an SMF+core packet gateway (SMF+PGW-C) device. The SMF+PGW-C can simultaneously realize the functions of the SMF and the PGW-C.

Optionally, FIG. 1 exemplarily illustrates one access network device, one core network device, and two terminal devices. Optionally, the communication system 100 may include multiple access network devices and may include other numbers of terminal devices within the coverage area of each of the access network devices, which will not be limited in embodiments of the present disclosure. Optionally, the communication system 100 may also include a mobile management entity (MME), a unified data management (UDM), an authentication server function (AUSF), a user plane function (UPF), a signalling gateway (SGW), and other network entities, which will not be limited in embodiments of the present disclosure.

It may be understood that the terms “system” and “network” herein are usually used interchangeably throughout this disclosure. The term “and/or” herein only describes an association relationship between associated objects, which means that there can be three relationships. For example, A and/or B can mean A alone, both A and B exist, and B alone. The terms “first” or “second” herein only refer to a certain object or an object, and generally refer to a generic meaning rather than a particular object, for example, a first network slice refers to a certain network slice. In addition, the character “/” herein generally indicates that the associated objects are in an “or” relationship.

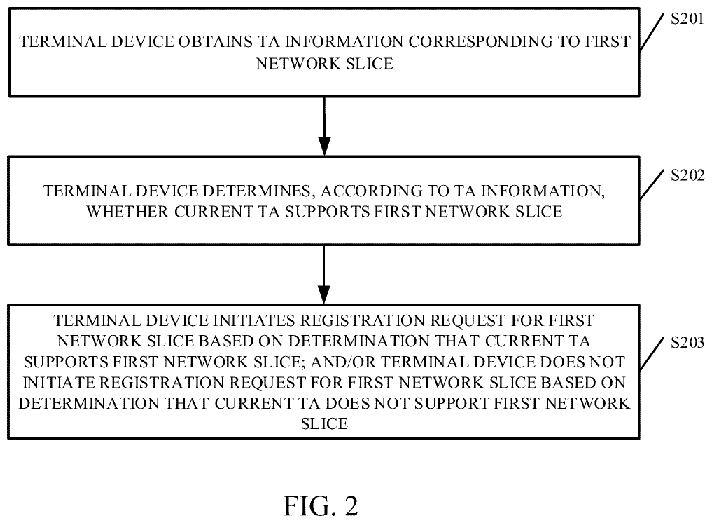

As illustrated in FIG. 2, FIG. 2 illustrates a method for requesting a network slice provided in embodiments of the present disclosure. The method is applicable to the communication system illustrated in FIG. 1 above and includes the following.

At S201, a terminal device obtains tracking area (TA) information corresponding to a first network slice.

In embodiments of the present disclosure, before the terminal device obtains the TA information corresponding to the first network slice, the terminal device may send a registration request to a core network device. Optionally, the registration request may carry network slice selection assistance information (NSSAI) requested by the terminal device (i.e., requested NSSAI). Then the core network device may respond to the registration request to obtain subscribed NSSAI of the terminal device from unified data management (UDM). Further, when the registration request does not carry the requested NSSAI of the terminal device, the core network device may determine, according to the subscribed NSSAI of the terminal device, whether to allow the terminal device to register with the network slice, where default subscribed NSSAI of the terminal device is NSSAI that the core network device allows the terminal device to register (i.e., allowed NSSAI). Optionally, when the registration request carries the requested NSSAI of the terminal device, the core network device may determine, according to the subscribed NSSAI of the terminal device and the requested NSSAI of the terminal device, whether to allow the terminal device to register with the network slice, where an intersection of the subscribed NSSAI of the terminal device and the requested NSSAI of the terminal device is the NSSAI that the core network device allows the terminal device to register.

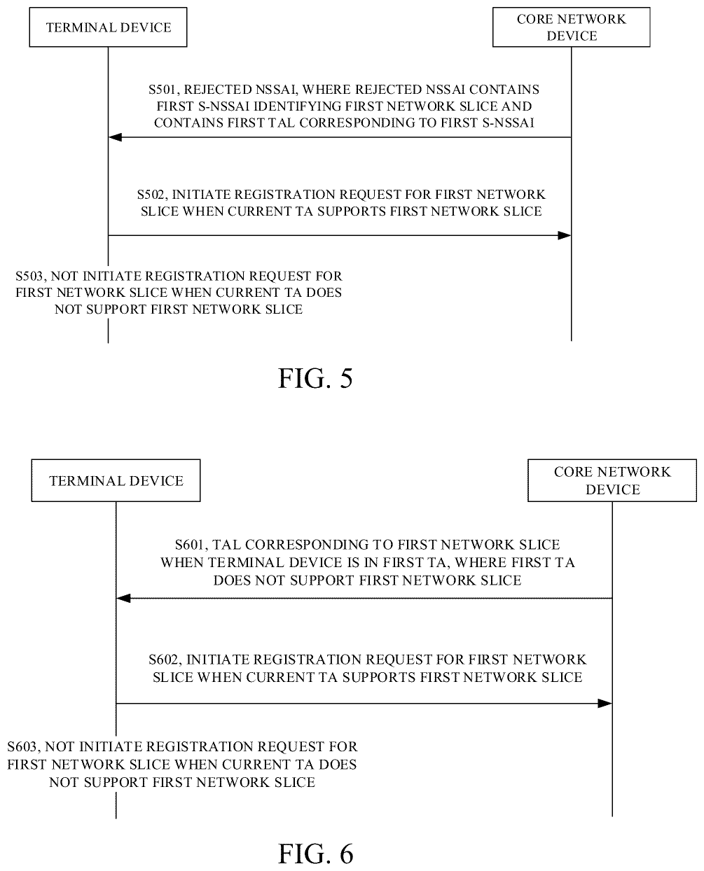

In a specific embodiment, after the core network device receives the registration request from the terminal device, the core network device may configure one or more TA information for the terminal device, where one TA information corresponds to one network slice, and different TA information correspond to different network slices. For example, the core network device may configure the TA information corresponding to the first network slice for the terminal device. For example, assuming that there are three network slices, i.e., network slice 1, network slice 2, and network slice 3 respectively, then there are three pieces of TA information configured by the core network device for the terminal device, i.e., TA information corresponding to network slice 1, TA information corresponding to network slice 2, and TA information corresponding to network slice 3 respectively. For a specific manner in which the core network device configures the TA information for the terminal device, references may be made to descriptions of embodiments illustrated in FIG. 4, FIG. 5, or FIG. 6.

Optionally, the core network device may be an AMF. If the terminal device is roaming, the core network device may be an AMF of a roaming public land mobile network (PLMN); and if the terminal device is in its home area, the core network device may be an AMF of a home PLMN.

Optionally, the TA information corresponding to the network slice may contain a first tracking area list (TAL) supporting the network slice, that is, the first TAL corresponding to the network slice, where the first TAL may include one or more TAs supporting the network slice. Optionally, the TA information corresponding to the network slice may contain a first TA array supporting the network slice, where the first TA array includes one or more TAs supporting the network slice. Optionally, the TA information corresponding to the network slice may contain a first TA matrix supporting the network slice, where the first TA matrix includes one or more TAs supporting the network slice. Optionally, the TA information corresponding to the network slice may contain one or more TAs supporting the network slice. For example, the TA information corresponding to the first network slice may contain a first TAL supporting the first network slice, where the first TAL includes one or more TAs supporting the first network slice.

Optionally, the terminal device may obtain the TA information corresponding to the first network slice as follows. The terminal device receives a first non-access stratum (NAS) sent by the core network device, where the first NAS message may contain the first TAL corresponding to the first network slice. Optionally, the first NAS message may also contain a TAL corresponding to another network slice, and the another network slice refers to a network slice different from the first network slice.

Optionally, the terminal device may obtain the TA information corresponding to the first network slice as follows. After the terminal device sends the registration request to the core network device, the core network device may send the first NAS message to the terminal device, and then the terminal device may store the first NAS message. When the terminal device needs to request the first network slice, the terminal device may obtain the first TAL corresponding to the first network slice from the stored first NAS message.

Optionally, the first NAS message may contain configured NSSAI, where the configured NSSAI contains first single-NSSAI (S-NSSAI) and a first TAL corresponding to the first S-NSSAI. Alternatively, the first NAS message may contain the configured NSSAI and the first TAL corresponding to the first S-NSSAI, where the configured NSSAI contains the first S-NSSAI.

Optionally, the first NAS message may contain rejected NSSAI, where the rejected NSSAI contains the first S-NSSAI and the first TAL corresponding to the first S-NSSAI. Alternatively, the first NAS message may contain the rejected NSSAI and the first TAL corresponding to the first S-NSSAI, where the rejected NSSAI contains the first S-NSSAI.

Optionally, the rejected NSSAI may further contain a rejected cause value corresponding to the first S-NSSAI, where the rejected cause value indicates that the current TA does not support the first S-NSSAI.

Optionally, the terminal device may further delete the first S-NSSAI from the rejected NSSAI. Exemplarily, the terminal device may delete the first S-NSSAI when the terminal device moves to a second TA.

Optionally, the terminal device may receive the first NAS message sent by the core network device as follows. The terminal device receives the first NAS message sent by the core network device when the terminal device is in the first TA, where the first TA does not support the first network slice.

The first network slice may refer to a network slice that the terminal device needs to request.

A TAL supporting any network slice may include a TA in a registration area (RA) in which the terminal device is located. Optionally, the TAL supporting any network slice may include a TA in the PLMN. The PLMN may be a currently registered PLMN of the terminal device and/or a PLMN equivalent to the currently registered PLMN.

At S202, the terminal device determines, according to the TA information, whether the current TA supports the first network slice.

In a specific embodiment, when the terminal device needs to request the first network slice, the terminal device may determine, according to the TA information, whether the TA in which the terminal device is currently located supports the first network slice. The terminal device may initiate a registration request for the first network slice based on a determination that the TA in which the terminal device is currently located supports the first network slice; and/or the terminal device may skip initiating the registration request for the first network slice based on a determination that the TA in which the terminal device is currently located does not support the first network slice.

Optionally, when the TA information contains the first TAL supporting the first network slice, the terminal device may determine, according to the TA information, whether the current TA supports the first network slice as follows. The terminal device determines whether the current TA is present in the first TAL. The terminal device determines that the current TA supports the first network slice based on a determination that the current TA of the terminal device is present in the first TAL; and/or the terminal device determines that the current TA does not support the first network slice based on a determination that the current TA of the terminal device is absent in the first TAL.

Optionally, when the TA information contains the first TA array supporting the first network slice, the terminal device may determine, according to the TA information, whether the current TA supports the first network slice as follows. The terminal device determines whether the current TA is present in the first TA array. The terminal device determines that the current TA supports the first network slice based on a determination that the current TA of the terminal device is present in the first TA array; and/or the terminal device determines that the current TA does not support the first network slice based on a determination that the current TA of the terminal device is absent in the first TA array.

Optionally, when the TA information contains the first TA matrix supporting the first network slice, the terminal device may determine, according to the TA information, whether the current TA supports the first network slice as follows. The terminal device determines whether the current TA is present in the first TA matrix. The terminal device determines that the current TA supports the first network slice based on a determination that the current TA of the terminal device is present in the first TA matrix; and/or the terminal device determines that the current TA does not support the first network slice based on a determination that the current TA of the terminal device is absent in the first TA matrix.

Optionally, when the TA information contains the one or more TAs supporting the first network slice, the terminal device may determine, according to the TA information, whether the current TA supports the first network slice as follows. The terminal device determines whether the current TA is present in the one or more TAs. The terminal device determines that the current TA supports the first network slice based on a determination that the current TA of the terminal device is present in the one or more TAs; and/or the terminal device determines that the current TA does not support the first network slice based on a determination that the current TA of the terminal device is absent in the one or more TAs.

At S203, the terminal device initiates the registration request for the first network slice based on the determination that the current TA supports the first network slice; and/or the terminal device does not initiate the registration request for the first network slice based on the determination that the current TA does not support the first network slice.

In a specific embodiment, when the terminal device needs to request the first network slice and the TA in which the terminal device is currently located supports the first network slice, the terminal device may send the registration request to the core network device, where the registration request may contain the requested NSSAI, and the requested NSSAI may contain the first S-NSSAI. Optionally, when the terminal device needs to request the first network slice and the TA in which the terminal device is currently located does not support the first network slice, the terminal device may not send the registration request to the core network device.

Optionally, when the terminal device needs to request the first network slice, the terminal device may determine whether the TA in which the terminal device is currently located is present in the TAL supporting the first network slice. If the TA in which the terminal device is currently located is present in the TAL supporting the first network slice, i.e., the current TA supports the first network slice, the terminal device may initiate the registration request for the first network slice, i.e., the terminal device sends the registration request including the first S-NSSAI to the core network device. If the TA in which the terminal device is currently located is absent in the TAL supporting the first network slice, i.e., the current TA does not support the first network slice, the terminal device may not initiate the registration request for the first network slice, i.e., the terminal device does not send the registration request including the first S-NSSAI to the core network device.

The current TA refers to the current TA of the terminal device, or the TA in which the terminal device is currently located. The current TA refers to a TA in which the terminal device is located when determining whether to send the registration request including the first S-NSSAI to the core network device.

In embodiments of the present disclosure, when the terminal device needs to request the first network slice, the terminal device initiates the registration request for the first network slice only if the TA in which the terminal device is currently located supports the first network slice. The terminal device does not initiate the registration request for the first network slice if the TA in which the terminal device is currently located does not support the first network slice. In this way, registration of the network slice by the terminal device can be controlled, an invalid registration request can be avoided, and signaling overhead can be saved.

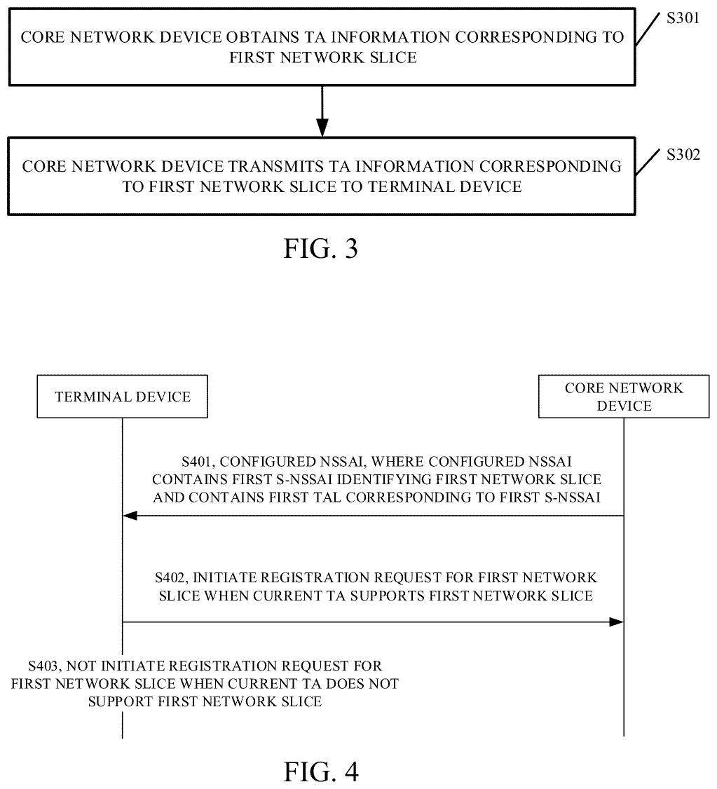

As illustrated in FIG. 3, FIG. 3 illustrates another method for requesting a network slice provided in embodiments of the present disclosure. The method is applicable to the communication system illustrated in FIG. 1 above and includes the following.

At S301, a core network device obtains TA information corresponding to a first network slice.

In embodiments of the present disclosure, before the core network device obtains the TA information corresponding to the first network slice, the core network device may receive a registration request sent by a terminal device. Optionally, the registration request may carry requested NSSAI of the terminal device, and then the core network device may respond to the registration request to obtain subscribed NSSAI of the terminal device from UDM. Further, when the registration request does not carry the requested NSSAI of the terminal device, the core network device may determine, according to the subscribed NSSAI of the terminal device, whether to allow the terminal device to register with the network slice, where default subscribed NSSAI of the terminal device is NSSAI that the core network device allows the terminal device to register with (i.e., allowed NSSAI). Optionally, when the registration request carries the requested NSSAI of the terminal device, the core network device may determine, according to the subscribed NSSAI of the terminal device and the requested NSSAI of the terminal device, whether to allow the terminal device to register with the network slice, where an intersection of the subscribed NSSAI of the terminal device and the requested NSSAI of the terminal device is the NSSAI that the core network device allows the terminal device to register.

In a specific embodiment, after the core network device receives the registration request from the terminal device, the core network device may configure one or more TA information for the terminal device, where one TA information corresponds to one network slice, and different TA information correspond to different network slices. For example, the core network device may configure the TA information corresponding to the first network slice for the terminal device. For a specific manner in which the core network device configures the TA information for the terminal device, references may be made to descriptions of embodiments illustrated in FIG. 4, FIG. 5, or FIG. 6.

Optionally, if the terminal device is in roaming, the core network device may be an AMF of a roaming PLMN; and if the terminal device is in its home area, the core network device may be an AMF of a home PLMN.

Optionally, the TA information corresponding to the network slice may contain a first TAL supporting the network slice, that is, the first TAL corresponding to the network slice, where the first TAL may include one or more TAs supporting the network slice. Optionally, the TA information corresponding to the network slice may contain a first TA array supporting the network slice, where the first TA array includes one or more TAs supporting the network slice. Optionally, the TA information corresponding to the network slice may contain a first TA matrix supporting the network slice, where the first TA matrix includes one or more TAs supporting the network slice. Optionally, the TA information corresponding to the network slice may contain one or more TAs supporting the network slice.

A TAL supporting any network slice may include a TA in an RA in which the terminal device is located. Optionally, the TAL supporting any network slice may include a TA in the PLMN. The PLMN may be a currently registered PLMN of the terminal device and/or a PLMN equivalent to the currently registered PLMN.

At S302, the core network device sends the TA information corresponding to the first network slice to the terminal device.

Optionally, when the TA information corresponding to the first network slice contains a first TAL supporting the first network slice, the core network device may send the first NAS message to the terminal device, where the first NAS message may contain the first TAL corresponding to the first network slice. Optionally, the first NAS message may further contain a TAL corresponding to another network slice, and the another network slice refers to a network slice different from the first network slice.

Optionally, when the TA information corresponding to the first network slice contains one or more TAs supporting the first network slice, the core network device may send the first NAS message to the terminal device, where the first NAS message may contain the one or more TAs supporting the first network slice. Optionally, the first NAS message may further contain one or more TAs supporting the another network slice.

Optionally, when the TA information corresponding to the first network slice contains a first TA array supporting the first network slice, the core network device may send the first NAS message to the terminal device, where the first NAS message may contain the first TA array supporting the first network slice.

Optionally, when the TA information corresponding to the first network slice contains a first TA matrix supporting the first network slice, the core network device may send the first NAS message to the terminal device, where the first NAS message may contain the first TA matrix supporting the first network slice.

In embodiments of the present disclosure, the core network device sends the TA information corresponding to the first network slice to the terminal device. When the terminal device needs to request the first network slice, the terminal device initiates the registration request for the first network slice only if the TA in which the terminal device is currently located supports the first network slice. The terminal device does not initiate the registration request for the first network slice if the TA in which the terminal device is currently located does not support the first network slice. In this way, registration of the network slice by the terminal device can be controlled, an invalid registration request can be avoided, and signaling overhead can be saved.

As illustrated in FIG. 4, FIG. 4 illustrates another method for requesting a network slice provided in embodiments of the present disclosure. The method is applicable to the communication system illustrated in FIG. 1 above and includes the following.

At S401, a terminal device receives configured NSSAI sent by a core network device, where the configured NSSAI contains first S-NSSAI identifying a first network slice and contains a first TAL corresponding to the first S-NSSAI.

In a specific embodiment, after the core network device receives a registration request from the terminal device, the core network device may send the configured NSSAI to the terminal device, where the configured NSSAI contains one or more S-NSSAI and one or more TALs. One TAL corresponds to one S-NSSAI, and different TALs correspond to different S-NSSAI. For example, the configured NSSAI may contain the first S-NSSAI and the first TAL corresponding to the first S-NSSAI. For example, assuming that the configured NSSAI contains three S-NSSAI, i.e., S-NSSAI for network slice 1, S-NSSAI for network slice 2, and S-NSSAI for network slice 3 respectively, then the core network device may configure the terminal device with three TALs, i.e., a TAL supporting network slice 1, a TAL supporting network slice 2, and a TAL supporting network slice 3 respectively.

Optionally, the one or more TALs configured by the core network device may be parameters independent of the configured NSSAI. In other words, the core network device may send the configured NSSAI and the one or more TALs to the terminal device.

At S402, the terminal device initiates a registration request for the first network slice based on a determination that a current TA supports the first network slice, where the registration request contains requested NSSAI, and the requested NSSAI contains the first S-NSSAI identifying the first network slice.

In a specific embodiment, when the terminal device needs to request the first network slice and the TA in which the terminal device is currently located supports the first network slice, the terminal device may send the registration request to the core network device, where the registration request may contain the requested NSSAI, and the requested NSSAI contains the first S-NSSAI.

Optionally, when the terminal device needs to request the first network slice, the terminal device may determine whether the TA in which the terminal device is currently located is present in the TAL supporting the first network slice. If the TA in which the terminal device is currently located is present in the TAL supporting the first network slice, i.e., the TA in which the terminal device is currently located supports the first network slice, the terminal device may initiate the registration request for the first network slice, i.e., the terminal device sends the registration request including the first S-NSSAI to the core network device.

At S403, the terminal device does not initiate the registration request for the first network slice based on a determination that the current TA does not support the first network slice.

In a specific embodiment, when the terminal device needs to request the first network slice and the TA in which the terminal device is currently located does not support the first network slice, the terminal device may not send the registration request for the first network slice to the core network device.

Optionally, when the terminal device needs to request the first network slice, the terminal device may determine whether the TA in which the terminal device is currently located is present in the TAL supporting the first network slice. If the TA in which the terminal device is currently located is absent in the TAL supporting the first network slice, i.e., the TA in which the terminal device is currently located does not support the first network slice, the terminal device may not initiate the registration request for the first network slice, i.e., the terminal device does not send the registration request including the first S-NSSAI to the core network device.

In embodiments of the present disclosure, the core network device sends the configured NSSAI to the terminal device, where the configured NSSAI contains the first S-NSSAI and the first TAL corresponding to the first S-NSSAI. The terminal device initiates the registration request for the first network slice based on the determination that the current TA supports the first network slice; and/or the terminal device does not initiate the registration request for the first network slice based on the determination that the current TA does not support the first network slice. In this way, registration of the network slice by the terminal device can be controlled, an invalid registration request can be avoided, and signaling overhead can be saved.

As illustrated in FIG. 5, FIG. 5 illustrates yet another method for requesting a network slice provided in embodiments of the present disclosure. The method is applicable to the communication system illustrated in FIG. 1 above and includes the following.

At S501, a terminal device receives rejected NSSAI sent by a core network device, where the rejected NSSAI contains first S-NSSAI identifying a first network slice and contains a first TAL corresponding to the first S-NSSAI.

In a specific embodiment, after the core network device receives a registration request from the terminal device, the core network device may determine one or more network slices that are not supported in the TA in which the terminal device is currently located, as well as one or more TALs, and thus obtain the rejected NSSAI. One TAL supports one network slice as determined above, and different TALs support different network slices as determined above. The TA where the terminal device is currently located refers to the TA where the terminal device is located when initiating the registration request. For example, the TA where the terminal device is located when initiating the registration request may be a first TA. Based on that the one or more TALs may be included in the rejected NSSAI, the core network device may send the rejected NSSAI to the terminal device, and the rejected NSSAI may contain one or more S-NSSAI identifying the one or more network slices determined above, and the one or more TALs. For example, the rejected NSSAI may contain the first S-NSSAI identifying the first network slice and the first TAL corresponding to the first S-NSSAI. For example, assuming that network slice 1, network slice 2, and network slice 3 are not supported in the TA in which the terminal device is currently located, then the core network device may configure a TAL supporting network slice 1, a TAL supporting network slice 2, and a TAL supporting network slice 3, and further the core network device may send the rejected NSSAI to the terminal device, where the rejected NSSAI may contain S-NSSAI for network slice 1, S-NSSAI for network slice 2, S-NSSAI for network slice 3, the TAL supporting network slice 1, the TAL supporting network slice 2, and the TAL supporting network slice 3.

In embodiments of the present disclosure, in the case where the terminal device needs to request any S-NSSAI in the rejected NSSAI, since the TA in which the terminal device is located when initiating the registration request (i.e., the first TA) does not support any S-NSSAI in the rejected NSSAI, the terminal device does not initiate the registration request for any S-NSSAI in the rejected NSSAI when in the first TA.

Optionally, the one or more TALs configured by the core network device may be parameters independent of the rejected NSSAI. In other words, the core network device may send the rejected NSSAI and the one or more TALs to the terminal device, and the rejected NSSAI may contain the one or more S-NSSAI. For example, the core network device may send the rejected NSSAI and the first TAL corresponding to the first S-NSSAI to the terminal device, and the rejected NSSAI may contain the first S-NSSAI.

In a feasible embodiment, the rejected NSSAI may further contain a rejected cause value corresponding to target S-NSSAI, and the rejected cause value indicates that the current TA does not support the target S-NSSAI. For example, the rejected NSSAI may further contain a rejected cause value corresponding to the first S-NSSAI, and the rejected cause value indicates that the current TA does not support the first S-NSSAI. The target S-NSSAI may contain the one or more S-NSSAI in the rejected NSSAI, that is, the target S-NSSAI may contain some or all of S-NSSAI in the rejected NSSAI. In embodiments of the present disclosure, different TAs may support different network slices, and therefore, when an S-NSSAI is available in some of the TAs in the RA in which the terminal device is located, i.e., the S-NSSAI is supported by some of the TAs in the RA in which the terminal device is located but is not supported by other TAs in the RA in which the terminal device is located, the S-NSSAI is the target S-NSSAI, and the rejected cause value corresponding to the S-NSSAI may be indicate that the current TA does not support the S-NSSAI, i.e., the S-NSSAI is not available in the current TA. In addition, if an existing rejected cause value may be reused for an S-NSSAI in the rejected NSSAI, the rejected cause value corresponding to the S-NSSAI can be the existing rejected cause value. The existing rejected cause value can include one or more of: S-NSSAI not available in the current PLMN or SNPN; S-NSSAI not available in the current RA; S-NSSAI not available due to the failed or revoked network slice-specific authentication and authorization; or S-NSSAI not available due to maximum number of UEs reached. In embodiments of the present disclosure, each S-NSSAI in the rejected NSSAI corresponds to one rejected cause value.

In a feasible embodiment, if the terminal device receives the rejected NSSAI sent by the core network device, where the rejected NSSAI contains one or more S-NSSAI and one or more TALs, the terminal device may store the rejected NSSAI. For example, the terminal device may store the rejected NSSAI in a memory or an external storage. If the terminal device receives the rejected NSSAI and the one or more TALs sent by the core network device, the terminal device may store the rejected NSSAI and the one or more TALs. For example, the terminal device may store the rejected NSSAI and the one or more TALs in the memory or the external storage. Specifically, the terminal device may store S-NSSAI with the same rejected cause value in one list. For example, assuming that the rejected NSSAI contains the S-NSSAI for network slice 1, the S-NSSAI for network slice 2, and the S-NSSAI for network slice 3, and that the S-NSSAI for network slice 1 reuses the existing cause value “S-NSSAI not available in the current RA”, and both the S-NSSAI for network slice 2 and the S-NSSAI for network slice 3 correspond to a new cause value “S-NSSAI not available in the current TA”, then the terminal device can store the S-NSSAI for network slice 1 to a first list in which all S-NSSAI share the existing cause value, and the terminal device may further store the S-NSSAI for network slice 2 and the S-NSSAI for network slice 3 to a second list in which all S-NSSAI correspond to the new cause value. Optionally, the terminal device may store the rejected NSSAI in the same list.

Further, if the rejected cause value corresponding to the first S-NSSAI indicates that the current TA does not support the first S-NSSAI, the first S-NSSAI may be available in a second TA when the terminal device moves from the first TA to the second TA. However, if the first S-NSSAI is not deleted from the rejected NSSAI, the terminal device may still determine, based on the rejected cause value corresponding to the first S-NSSAI, that the first S-NSSAI is not available in the second TA, resulting in a misjudgment of the first S-NSSAI. Therefore, the first S-NSSAI may be deleted from the rejected NSSAI when the terminal device moves to the second TA. Specifically, in the case where the terminal device stores the rejected NSSAI in the same list, the terminal device may delete the first S-NSSAI from the list when the terminal device moves to the second TA. In the case where the terminal device stores the S-NSSAI with the same cause value in one list, the terminal device may delete the first S-NSSAI from the corresponding list when the terminal device moves to the second TA. For example, both the S-NSSAI for network slice 2 and the S-NSSAI for network slice 3 correspond to the new cause value “S-NSSAI not available in the current TA”, the S-NSSAI for network slice 2 and the S-NSSAI for network slice 3 are stored in the second list, and the terminal device deletes the S-NSSAI for network slice 2 and the S-NSSAI for network slice 3 from the second list when the terminal device moves to the second TA. In other words, the terminal device may delete the S-NSSAI with the new cause value in the rejected NSSAI when the terminal device moves to the second TA.

At S502, the terminal device initiates the registration request for the first network slice based on a determination that the current TA supports the first network slice.

When the terminal device moves from the first TA to the second TA, the terminal device sends the registration request for the first network slice to the core network device when the terminal device needs to request the first network slice and the second TA is present in the TAL supporting the first network slice.

When the terminal device moves from the first TA to the second TA, the second TA is the TA in which the terminal device is currently located, where the TA in which the terminal device is currently located refers to the TA in which the terminal device is located when determining whether to send the registration request including the first S-NSSAI to the core network device. In the TA in which the terminal device is currently located, when the terminal device needs to request the first network slice, the terminal device can determine whether the TA in which the terminal device is currently located is present in the TAL supporting the first network slice. If the TA in which the terminal device is currently located is present in the TAL supporting the first network slice, the terminal device may initiate the registration request for the first network slice, i.e., the terminal device sends the registration request including the first S-NSSAI to the core network device.

At S503, the terminal device does not initiate the registration request for the first network slice based on a determination that the current TA does not support the first network slice.

When the terminal device moves from the first TA to the second TA, the terminal device does not send the registration request for the first network slice to the core network device when the terminal device needs to request the first network slice and the second TA is absent in the TAL supporting the first network slice.

When the terminal device moves from the first TA to the second TA, the second TA is the TA in which the terminal device is currently located. In the TA in which the terminal device is currently located, when the terminal device needs to request the first network slice, the terminal device can determine whether the TA in which the terminal device is currently located is present in the TAL supporting the first network slice. If the TA in which the terminal device is currently located is absent in the TAL supporting the first network slice, the terminal device may not initiate the registration request for the first network slice, i.e., the terminal device does not send the registration request including the first S-NSSAI to the core network device.

In embodiments of the present disclosure, the core network device sends the rejected NSSAI to the terminal device, and the rejected NSSAI contains the first S-NSSAI and the TAL corresponding to the first S-NSSAI. The terminal device initiates the registration request for the first network slice based on the determination that the current TA supports the first network slice, and/or the terminal device does not initiate the registration request for the first network slice based on the determination that the current TA does not support the first network slice. In this way, registration of the network slice by the terminal device can be controlled, an invalid registration request can be avoided, and signaling overhead can be saved.

As illustrated in FIG. 6, FIG. 6 illustrates yet another method for requesting a network slice provided in embodiments of the present disclosure. The method is applicable to the communication system illustrated in FIG. 1 above and includes the following.

At S601, when a terminal device is in a first TA, the terminal device receives a TAL corresponding to a first network slice sent by a core network device, where the first TA does not support the first network slice.

In a specific embodiment, after the core network device receives a registration request from the terminal device, the core network device may determine one or more network slices that are not supported in a TA in which the terminal device is currently located, where the TA in which the terminal device is currently located refers to the TA in which the terminal device is located when initiating the registration request. For example, the TA in which the terminal device is located when initiating the registration request may be the first TA. The core network device may then configure one or more TALs, where one TAL supports one network slice as determined above, and different TALs support different network slices as determined above. The core network device sends the one or more TALs above to the terminal device. For example, assuming that network slice 1, network slice 2, and network slice 3 are not supported in the TA in which the terminal device is currently located, then the core network device may configure a TAL supporting network slice 1, a TAL supporting network slice 2, and a TAL supporting network slice 3, and thus the core network device may send to the terminal device the TAL supporting network slice 1, the TAL supporting network slice 2, and the TAL supporting network slice 3.

Compared with the embodiments illustrated in FIG. 4 or FIG. 5, in embodiments of the present disclosure, after the core network device determines the network slice(s) not supported in the TA in which the terminal device is currently located, the S-NSSAI of the network slice not supported in the TA in which the terminal device is currently located, will not be placed in any of allowed NSSAI or rejected NSSAI by the core network device. In other words, the core network device sends the one or more TALs above to the terminal device. Based on this, when the terminal device is in the first TA, the terminal device does not initiate a registration request for the S-NSSAI corresponding to the one or more TALs above in the first TA because the S-NSSAI corresponding to the one or more TALs above is not in the allowed NSSAI.

In a feasible embodiment, if the terminal device receives the one or more TALs sent by the core network device, the terminal device may store the one or more TALs in a memory or an external storage.

At S602, the terminal device initiates the registration request for the first network slice based on a determination that the current TA supports the first network slice.

When the terminal device moves from the first TA to the second TA, the terminal device sends the registration request for the first network slice to the core network device when the terminal device needs to request the first network slice and the second TA is present in the TAL supporting the first network slice.

When the terminal device moves from the first TA to the second TA, the second TA is the TA in which the terminal device is currently located, where the TA in which the terminal device is currently located refers to the TA in which the terminal device is located when determining whether to send the registration request including the first S-NSSAI to the core network device. In the TA in which the terminal device is currently located, when the terminal device needs to request the first network slice, the terminal device can determine whether the TA in which the terminal device is currently located is present in the TAL supporting the first network slice. If the TA in which the terminal device is currently located is present in the TAL supporting the first network slice, the terminal device may initiate the registration request for the first network slice, i.e., the terminal device sends the registration request including the first S-NSSAI to the core network device.

At S603, the terminal device does not initiate the registration request for the first network slice based on a determination that the current TA does not support the first network slice.

When the terminal device moves from the first TA to the second TA, the terminal device does not send the registration request for the first network slice to the core network device when the terminal device needs to request the first network slice and the second TA is absent in the TAL supporting the first network slice.

When the terminal device moves from the first TA to the second TA, the second TA is the TA in which the terminal device is currently located. In the TA in which the terminal device is currently located, when the terminal device needs to request the first network slice, the terminal device can determine whether the TA in which the terminal device is currently located is present in the TAL supporting the first network slice. If the TA in which the terminal device is currently located is absent in the TAL supporting the first network slice, the terminal device may not initiate the registration request for the first network slice, i.e., the terminal device does not send the registration request including the first S-NSSAI to the core network device.

In embodiments of the present disclosure, when the terminal device is in the first TA, the core network device sends the TAL corresponding to the first network slice to the terminal device, where the first TA does not support the first network slice. The terminal device initiates the registration request for the first network slice based on the determination that the current TA supports the first network slice, and/or the terminal device does not initiate the registration request for the first network slice based on the determination that the current TA does not support the first network slice. In this way, registration of the network slice by the terminal device can be controlled, an invalid registration request can be avoided, and signaling overhead can be saved.

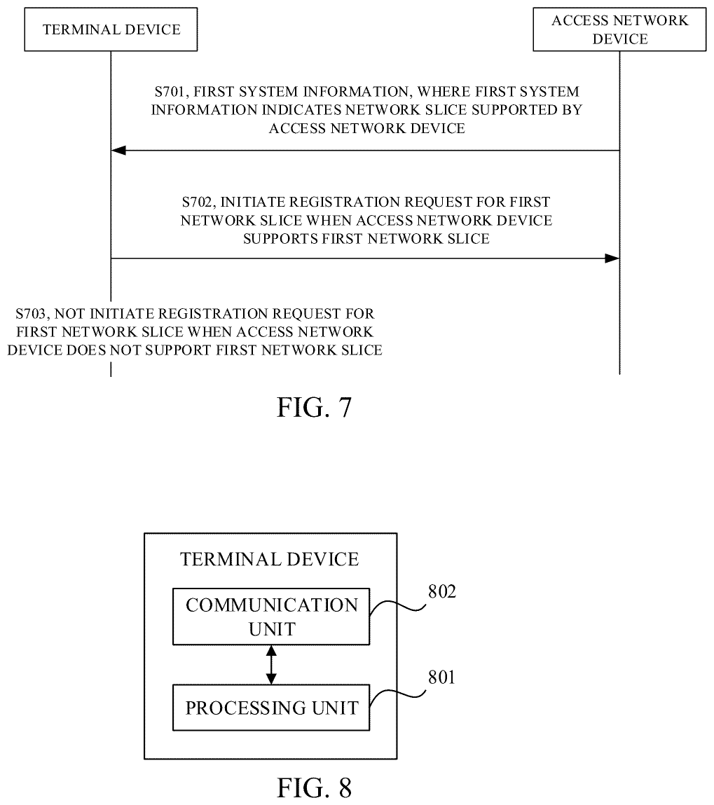

As illustrated in FIG. 7, FIG. 7 illustrates yet another method for requesting a network slice provided in embodiments of the present disclosure. The method is applicable to the communication system illustrated in FIG. 1 above and includes the following.

At S701, a terminal device receives first system information sent by an access network device, where the first system information indicates a network slice supported by the access network device.

In embodiments of the present disclosure, any access network device may broadcast system information, where the system information may indicate the network slice(s) supported by the access network device. For example, the system information may contain network slice information of the network slice supported by the access network device. The access network device may support one or more network slices. The network slice information may refer to information identifying the network slice, such as S-NSSAI, a network slice name, etc. Optionally, the system information may further contain a TA in which the access network device is located. The terminal device may then receive the system information broadcast by the access network device. For example, the terminal device located within the coverage area of the access network device may receive the system information broadcast by the access network device, i.e., the terminal device may receive the first system information sent by the access network device with a communication coverage covering the terminal device.

At S702, the terminal device initiates a registration request for the first network slice when the access network device supports the first network slice.

The terminal device may determine, according to the first system information, the network slice supported by the access network device, and then determine whether the first network slice is present in the network slice(s) supported by the access network device. The terminal device may initiate the registration request for the first network slice based on a determination that the first network slice is present in the network slice(s) supported by the access network device, i.e., the access network device supports the first network slice; and/or the terminal device may not initiate the registration request for the first network slice based on a determination that the first network slice is absent in the network slice(s) supported by the access network device, i.e., the access network device does not support the first network slice.

In a feasible embodiment, the network slice information in the first system information can be read by an access stratum of the terminal device, and the access stratum transmits the network slice information to a NAS of the terminal device. If the terminal device needs to request the first network slice, the NAS may determine whether the network slice information of the first network slice is present in the network slice information received from the access stratum. Based on a determination that the network slice information of the first network slice is present in the network slice information received from the access stratum, the NAS may determine that the access network device supports the first network slice, and then the terminal device may initiate the registration request for the first network slice to the access network device. Based on a determination that the network slice information of the first network slice is absent in the network slice information received from the access stratum, the NAS may determine that the access network device does not support the first network slice, and then the terminal device may not initiate the registration request for the first network slice.

At S703, the terminal device does not initiate the registration request for the first network slice when the access network device does not support the first network slice.

In a feasible embodiment, after the terminal device moves from a first cell to a second cell, the terminal device may receive the system information sent by the access network device in the second cell. If the terminal device needs to request the first network slice and the access network device in the second cell supports the first network slice, the terminal device initiates the registration request for the first network slice to the access network device in the second cell. If the terminal device needs to request the first network slice and the access network device in the second cell does not support the first network slice, the terminal device does not initiate the registration request for the first network slice to the access network device in the second cell. The second cell may refer to any neighboring cell of the terminal device.

Exemplarily, if the terminal device has poor signal quality in the first cell, the terminal device may search for the neighboring cell. After the terminal device leaves the first cell and enters the second cell, the terminal device may receive the system information broadcast by the access network device in the second cell. If the terminal device needs to request the first network slice and the access network device in the second cell supports the first network slice, the terminal device initiates the registration request for the first network slice to the access network device in the second cell. If the terminal device needs to request the first network slice and the access network device in the second cell does not support the first network slice, the terminal device does not initiate the registration request for the first network slice to the access network device in the second cell.

In a feasible embodiment, when the terminal device determines to move from the first cell to the second cell, i.e., when the terminal device is to move to the second cell, the terminal device receives the system information sent by the access network device in the second cell. If the terminal device needs to request the first network slice and the access network device in the second cell supports the first network slice, the terminal device initiates the registration request for the first network slice to the access network device in the second cell. If the terminal device needs to request the first network slice and the access network device in the second cell does not support the first network slice, the terminal device does not initiate the registration request for the first network slice to the access network device in the second cell.

Exemplarily, if the terminal device has poor signal quality in the first cell, the terminal device may search for the neighboring cell. When the terminal device determines to leave the current cell and enter the second cell, the terminal device may be triggered to search for the system information broadcast by the access network device in the second cell. If the terminal device needs to request the first network slice and the access network device in the second cell supports the first network slice, the terminal device initiates the registration request for the first network slice to the access network device in the second cell. If the terminal device needs to request the first network slice and the access network device in the second cell does not support the first network slice, the terminal device does not initiate the registration request for the first network slice to the access network device in the second cell.

In embodiments of the present disclosure, the terminal device receives the first system information sent by the access network device, and determines according to the first system information, whether the access network device supports the first network slice. The terminal device initiates the registration request for the first network slice based on the determination that the access network device supports the first network slice; and/or the terminal device does not initiate the registration request for the first network slice based on the determination that the access network device does not supports the first network slice. In this way, registration of the network slice by the terminal device can be controlled, an invalid registration request can be avoided, and signaling overhead can be saved.

The above mainly describes solutions of embodiments of the present disclosure from the perspective of interaction between network elements. It may be understood that, in order to implement the foregoing functions, the terminal device includes corresponding hardware structures and/or software modules for executing respective functions. Those of ordinary skill in the art will appreciate that units and algorithmic operations of various examples described in connection with embodiments herein may be implemented by hardware or by a combination of hardware and computer software. Whether these functions are performed by means of hardware or hardware driven by computer software depends on the application and the design constraints of the associated technical solution. Those skilled in the art may use different methods with regard to each particular application to implement the described functionality, but such methods should not be regarded as lying beyond the scope of the present disclosure.

In embodiments of the present disclosure, division of functional units of a terminal device may be implemented according to the foregoing method examples. For example, functional units may be divided to correspond to respective functions, or two or more functions may be integrated into one processing unit. The integrated unit may be implemented in a form of hardware, or may be implemented in a form of software program unit. It may be noted that the division of units in embodiments of the present disclosure is illustrative and is only a division of logical functions, and other manners of division may also available in practice.

In a case of using an integrated unit, FIG. 8 illustrates a block diagram of a possible functional unit composition of the terminal device involved in the above embodiments. The terminal device includes a processing unit 801 and a communication unit 802. The processing unit 801 is configured to obtain TA information corresponding to a first network slice and determine, according to the TA information, whether a current TA supports the first network slice. The communication unit 802 is configured to initiate a registration request for the first network slice based on a determination that the current TA supports the first network slice; and/or the communication unit 802 is configured to not initiate the registration request for the first network slice based on a determination that the current TA does not support the first network slice, where the registration request contains first S-NSSAI identifying the first network slice.

In an embodiment, the TA information contains a TAL supporting the first network slice, where the first TAL includes one or more TAs supporting the first network slice.

In an embodiment, the processing unit 801 configured to determine, according to the TA information, whether the current TA supports the first network slice, is configured to: determine that the current TA supports the first network slice when the current TA of the terminal device is present in the first TAL; and/or determine that the current TA does not support the first network slice when the current TA of the terminal device is absent in the first TAL.

In an embodiment, the processing unit 801 configured to obtain the TA information corresponding to the first network slice is configured to receive a NAS message sent by a core network device, where the first NAS message contains the first TAL corresponding to the first network slice.

In an embodiment, the first NAS message contains configured NSSAI, where the configured NSSAI contains the first S-NSSAI and the first TAL corresponding to the first S-NSSAI.

In an embodiment, the first NAS message contains the configured NSSAI and the first TAL corresponding to the first S-NSSAI, where the configured NSSAI contains the first S-NSSAI.

In an embodiment, the first NAS message contains rejected NSSAI, where the rejected NSSAI contains the first S-NSSAI and the first TAL corresponding to the first S-NSSAI.

In an embodiment, the first NAS message contains the rejected NSSAI and the first TAL corresponding to the first S-NSSAI, where the rejected NSSAI contains the first S-NSSAI.

In an embodiment, the rejected NSSAI further contains a rejected cause value corresponding to the first S-NSSAI, where the rejected cause value indicates that the current TA does not support the first S-NSSAI.

In an embodiment, the processing unit 801 is further configured to delete the first S-NSSAI from the rejected NSSAI.

In an embodiment, the processing unit 801 configured to delete the first S-NSSAI from the rejected NSSAI is configured to delete the first S-NSSAI when the terminal device moves a second TA.

In an embodiment, the communication unit 802 configured to receive the first NAS message sent by the core network device is configured to receive the first NAS message sent by the core network device when the terminal device is in a first TA, where the first TA does not support the first network slice.

In an embodiment, the one or more TAs include a TA in a current RA of the terminal device.

In an embodiment, the one or more TAs include a TA in a PLMN.

In an embodiment, the core network device is an AMF.

In embodiments of the present disclosure, the processing unit 801 is configured to obtain the TA information corresponding to the first network slice and determine according to the TA information, whether the current TA supports the first network slice. The communication unit 802 is then configured to initiate the registration request for the first network slice based on the determination that the current TA supports the first network slice; and/or the communication unit 802 is configured to not initiate the registration request for the first network slice based on the determination that the current TA does not support the first network slice. In this way, registration of the network slice by the terminal device can be controlled, an invalid registration request can be avoided, and signaling overhead can be saved.

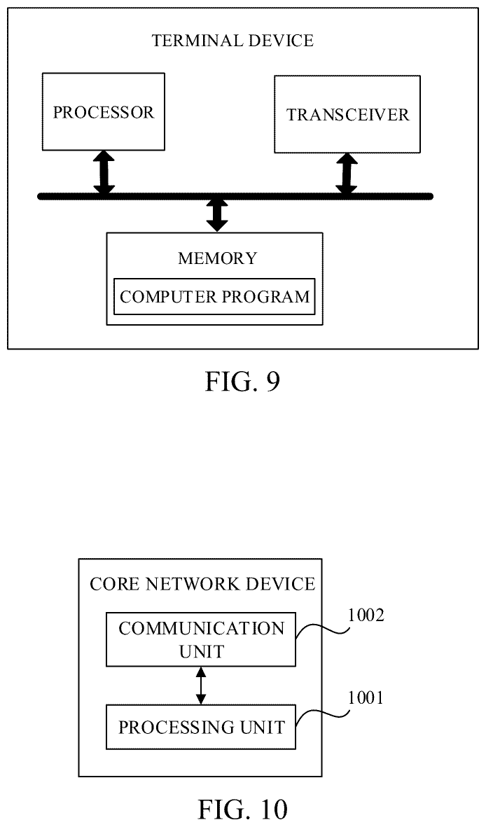

When the processing unit 801 is a processor and the communication unit 802 is a transceiver, the terminal device involved in embodiments of the present disclosure may be the terminal device illustrated in FIG. 9.

In another embodiment, in a case of using an integrated unit, FIG. 8 illustrates a block diagram of a possible functional unit composition of the terminal device involved in the above embodiments. The terminal device includes a communication unit 802 and a processing unit 801. The communication unit 802 is configured to receive first system information sent by an access network device, where the first system information indicates a network slice supported by the access network device. The processing unit 801 is configured to determine, according to the first system information, whether the access network device supports a first network slice. The communication unit 802 is further configured to initiate a registration request for the first network slice based on a determination that the access network device supports the first network slice; and/or the communication unit 802 is further configured to not initiate the registration request for the first network slice based on a determination that the access network device does not support the first network slice. The registration request contains first S-NSSAI identifying the first network slice. The processing unit 801 may be a processor or a controller, and the communication unit 802 may be a transceiver, a transceiving circuit, an RF chip, or the like.

In an embodiment, the communication unit 802 configured to receive the first system information sent by the access network device is configured to receive the first system information broadcast by the access network device.

In an embodiment, the communication unit 802 configured to receive the first system information sent by the access network device is configured to receive the first system information sent by the access network device in a second cell when the terminal device moves the second cell or the terminal device is to move to the second cell.

In embodiments of the present disclosure, the communication unit 802 is configured to receive the first system information sent by the access network device, and the processing unit 801 is configured to determine according to the first system information, whether the access network device supports the first network slice. The communication unit 802 is then configured to initiate the registration request for the first network slice based on the determination that the access network device supports the first network slice, and/or the communication unit 802 is configured to not initiate the registration request for the first network slice based on the determination that the access network device does not support the first network slice. In this way, registration of the network slice by the terminal device can be controlled, an invalid registration request can be avoided, and signaling overhead can be saved.

When the processing unit 801 is a processor and the communication unit 802 is a transceiver, the terminal device involved in embodiments of the present disclosure may be the terminal device illustrated in FIG. 9.

In embodiments of the present disclosure, division of functional units of a core network device may be implemented according to the foregoing method examples. For example, functional units may be divided to correspond to respective functions, or two or more functions may be integrated into one processing unit. The integrated unit may be implemented in a form of hardware, or may be implemented in a form of software program unit. It may be noted that the division of units in embodiments of the present disclosure is illustrative and is only a division of logical functions, and other manners of division may also available in practice.

In a case of using an integrated unit, FIG. 10 illustrates a block diagram of a possible functional unit composition of the core network device involved in the above embodiments. The core network device includes a communication unit 1002 and a processing unit 1001. The communication unit 1002 is configured to transmit TA information corresponding to a first network slice to a terminal device.

In an embodiment, the TA information contains a TAL supporting the first network slice, where the first TAL includes one or more TAs supporting the first network slice.

The processing unit 1001 may be configured to obtain the TA information corresponding to the first network slice. The processing unit 1001 may be a processor or a controller, and the communication unit 1002 may be a transceiver, a transceiving circuit, an RF chip, or the like.

In an embodiment, the communication unit 1002 configured to transmit the TA information corresponding to the first network slice to the terminal device is configured to transmit a first NAS message to the terminal device, where the first NAS message contains the first TAL corresponding to the first network slice.

In an embodiment, the first NAS message contains configured NSSAI, where the configured NSSAI contains first S-NSSAI and the first TAL corresponding to the first S-NSSAI.

In an embodiment, the first NAS message contains the configured NSSAI and the first TAL corresponding to the first S-NSSAI, where the configured NSSAI contains the first S-NSSAI.

In an embodiment, the first NAS message contains rejected NSSAI, where the rejected NSSAI contains the first S-NSSAI and the first TAL corresponding to the first S-NSSAI.

In an embodiment, the first NAS message contains the rejected NSSAI and the first TAL corresponding to the first S-NSSAI, where the rejected NSSAI contains the first S-NSSAI.

In an embodiment, the rejected NSSAI further contains a rejected cause value corresponding to the first S-NSSAI, where the rejected cause value indicates that the current TA does not support the first S-NSSAI.

In an embodiment, the communication unit 1002 configured to transmit a first NAS message to the terminal device is configured to transmit the first NAS message to the terminal device when the terminal device is in a first TA and the first TA does not support the first network slice.

In an embodiment, the one or more TAs include a TA in a current RA of the terminal device.

In an embodiment, the one or more TAs include a TA in a PLMN.

In an embodiment, the core network device is an AMF.

In embodiments of the present disclosure, the communication unit 1002 is configured to transmit the TA information corresponding to the first network slice to the terminal device, and the terminal device may determine according to the TA information, whether the current TA supports the first network slice. The terminal device then initiates the registration request for the first network slice based on the determination that the current TA supports the first network slice, and/or does not initiate the registration request for the first network slice based on the determination that the current TA does not support the first network slice. In this way, registration of the network slice by the terminal device can be controlled, an invalid registration request can be avoided, and signaling overhead can be saved.

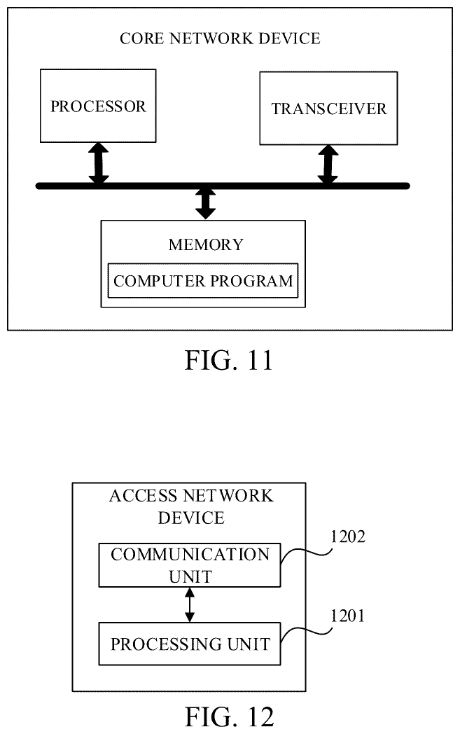

When the processing unit 1001 is a processor and the communication unit 1002 is a transceiver, the core network device involved in embodiments of the present disclosure may be the core network device illustrated in FIG. 11.

In embodiments of the present disclosure, division of functional units of an access network device may be implemented according to the foregoing method examples. For example, functional units may be divided to correspond to respective functions, or two or more functions may be integrated into one processing unit. The integrated unit may be implemented in a form of hardware, or may be implemented in a form of software program unit. It may be noted that, the division of units in embodiments of the present disclosure is illustrative and is only a division of logical functions, and other manners of division may also available in practice.

In a case of using an integrated unit, FIG. 12 illustrates a block diagram of a possible functional unit composition of the access network device involved in the above embodiments. The access network device includes a communication unit 1202 and a processing unit 1201. The communication unit 1202 is configured to transmit first system information to a terminal device, where the first system information indicates a network slice supported by the access network device.

In an embodiment, the communication unit 1202 configured to transmit the first system information to the terminal device is configured to broadcast the first system information to the terminal device.

The processing unit 1201 may be configured to obtain the first system information. The processing unit 1201 may be a processor or a controller, and the communication unit 1202 may be a transceiver, a transceiving circuit, an RF chip, or the like.

In embodiments of the present disclosure, the communication unit 1202 is configured to transmit the first system information to the terminal device, and the terminal device may determine according to the first system information, whether the access network device supports the first network slice. The terminal device then initiates the registration request for the first network slice based on a determination that the access network device supports the first network slice; and/or does not initiate the registration request for the first network slice based on a determination that the access network device does not support the first network slice. In this way, registration of the network slice by the terminal device can be controlled, an invalid registration request can be avoided, and signaling overhead can be saved.

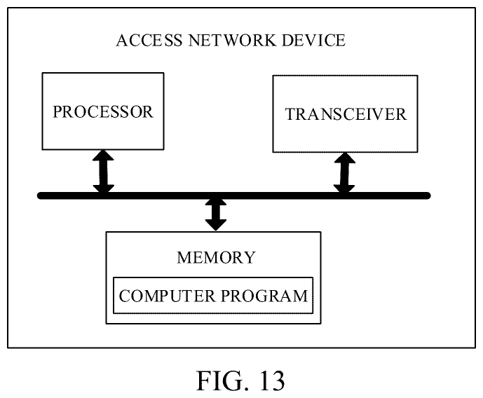

When the processing unit 1201 is a processor and the communication unit 1202 is a transceiver, the access network device involved in embodiments of the present disclosure may be the access network device illustrated in FIG. 13.

Embodiments of the present disclosure further provide a computer-readable storage medium storing a computer program for electronic data exchange, where the computer program causes the computer to perform some or all of the operations of the terminal device in the method embodiment above.

Embodiments of the present disclosure further provide a computer-readable storage medium storing a computer program for electronic data exchange, where the computer program causes the computer to perform some or all of the operations of the core network device in the method embodiment above.

Embodiments of the present disclosure further provide a computer-readable storage medium storing a computer program for electronic data exchange, where the computer program causes the computer to perform some or all of the operations of the access network device in the method embodiment above.

Embodiments of the present disclosure further provide a computer program product including a non-transitory computer-readable storage medium storing a computer program, and the computer program is operable with the computer to perform some or all of the operations of the terminal device in the method embodiment above. The computer program product may be a software installation package.

Embodiments of the present disclosure further provide a computer program product including a non-transitory computer-readable storage medium storing a computer program, and the computer program is operable with the computer to perform some or all of the operations of the core network device in the method embodiment above. The computer program product may be a software installation package.

Embodiments of the present disclosure further provide a computer program product including a non-transitory computer-readable storage medium storing a computer program, and the computer program is operable with the computer to perform some or all of the operations of the access network device in the method embodiment above. The computer program product may be a software installation package.

The operations of the method or algorithm described in embodiments of the present disclosure may be implemented by means of hardware, or may be implemented by executing software instructions by a processor. The software instructions can be implemented by corresponding software modules, which can be stored in a random access memory (RAM), a flash memory, a read-only memory (ROM), an erasable programmable ROM (EPROM), an electrically EPROM (EEPROM), registers, hard disk, mobile hard disk, compact disc (CD)-ROM, or any other form of storage medium known in the art. An exemplary storage medium is coupled to the processor, such that the processor can read information from the storage medium and write information to the storage medium. The storage medium can also be a component of the processor. The processor and the storage medium may be located in an ASIC. In addition, the ASIC can be located in a communication device such as the terminal or the network device. The processor and the storage medium may also be present as discrete components in the communication device.

Those skilled in the art will appreciate that, all or part of functions described in one or more of the embodiments can be implemented through software, hardware, firmware, or any other combination thereof. When implemented by software, all or part of the functions can be implemented in the form of a computer program product. The computer program product includes one or more computer instructions. When the computer instructions are applied and executed on a computer, all or part of the operations or functions of the embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable-medium or a data storage device such as a server, a data center, or the like which is integrated with one or more usable media. The usable medium can be a magnetic medium (such as a soft disc, a hard disc, or a magnetic tape), an optical medium (such as a digital video disc (DVD)), or a semiconductor medium (such as a solid state disk (SSD)), etc.

The embodiments described above describe in further detail purposes, technical solutions and advantages of the embodiments of the disclosure. It may be understood that, the above is only specific embodiments of embodiments of the disclosure, and are not used to limit the protection scope of embodiments of the disclosure. Any modification, equivalent substitution, improvement, and the like that is made on the basis of technical solutions of embodiments of the disclosure shall be included in the protection scope of embodiments of the disclosure.

What is claimed is:

1. A method for requesting a network slice, applicable to a terminal device and comprising:
obtaining tracking area (TA) information corresponding to a first network slice;
determining, according to the TA information, whether a current TA supports the first network slice; and
initiating a registration request for the first network slice based on a determination that the current TA supports the first network slice; and/or not initiating the registration request for the first network slice based on a determination that the current TA does not support the first network slice;
wherein the registration request contains first single-network slice selection assistance information (S-NSSAI) identifying the first network slice.

2. The method of claim 1, wherein the TA information contains a first tracking area list (TAL) supporting the first network slice, wherein the first TAL comprises one or more TAs supporting the first network slice.

3. The method of claim 2, wherein determining, according to the TA information, whether the current TA supports the first network slice comprises:
determining that the current TA supports the first network slice when the current TA of the terminal device is present in the first TAL; and/or
determining that the current TA does not support the first network slice when the current TA of the terminal device is absent in the first TAL.

4. The method of claim 2, wherein the obtaining comprises receiving a first non-access stratum (NAS) message sent by a core network device, wherein the first NAS message contains the first TAL corresponding to the first network slice.

5. The method of claim 4, wherein the first NAS message contains rejected NSSAI, wherein the rejected NSSAI contains the first S-NSSAI and the first TAL corresponding to the first S-NSSAI.

6. The method of claim 4, wherein receiving the first NAS message sent by the core network device comprises:
receiving the first NAS message sent by the core network device when the terminal device is in a first TA, wherein the first TA does not support the first network slice.

7. The method of claim 2, wherein the one or more TAs comprise a TA in a current registration area (RA) of the terminal device.

8. A terminal device, comprising:
a processor, a memory storing instructions, and a transceiver;
wherein the processor is coupled to the memory and to the transceiver;
wherein the instructions, when executed by the processor, cause the terminal device to:
obtain tracking area (TA) information corresponding to a first network slice; and
determine, according to the TA information, whether a current TA supports the first network slice; and
initiate a registration request for the first network slice based on a determination that the current TA supports the first network slice; and/or not initiate the registration request for the first network slice based on a determination that the current TA does not support the first network slice;
wherein the registration request contains first single-network slice selection assistance information (S-NSSAI) identifying the first network slice.

9. The terminal device of claim 8, wherein the TA information contains a first tracking area list (TAL) supporting the first network slice, wherein the first TAL comprises one or more TAs supporting the first network slice.

10. The terminal device of claim 9, wherein the instructions causing the terminal device to determine, according to the TA information, whether the current TA supports the first network slice cause the terminal device to:
determine that the current TA supports the first network slice when the current TA of the terminal device is present in the first TAL; and/or
determine that the current TA does not support the first network slice when the current TA of the terminal device is absent in the first TAL.

11. The terminal device of claim 9, wherein the instructions causing the terminal device to obtain TA information corresponding to the first network slice cause the terminal device to:
receive a first non-access stratum (NAS) message sent by a core network device, wherein the first NAS message contains the first TAL corresponding to the first network slice.

12. The terminal device of claim 11, wherein the instructions causing the terminal device to receive the first NAS message sent by the core network device cause the terminal device to:
receive the first NAS message sent by the core network device when the terminal device is in a first TA, wherein the first TA does not support the first network slice.

13. The terminal device of claim 9, wherein the one or more TAs comprise a TA in a current registration area (RA) of the terminal device.

14. A core network device, comprising:
a processor, a memory storing instructions, and a transceiver;
wherein the processor is coupled to the memory and to the transceiver;
wherein the instructions, when executed by the processor, cause the core network device to:
transmit, to a terminal device, tracking area (TA) information corresponding to a first network slice, wherein the TA information is used for the terminal device to determine whether a current TA supports the first network slice, and for the terminal device to initiate a registration request for the first network slice based on a determination that the current TA supports the first network slice, or not to initiate the registration request for the first network slice based on a determination that the current TA does not support the first network slice, wherein the registration request contains first single-network slice selection assistance information (S-NSSAI) identifying the first network slice.

15. The core network device of claim 14, wherein the TA information contains a first tracking area list (TAL) supporting the first network slice, wherein the first TAL comprises one or more TAs supporting the first network slice.

16. The core network device of claim 15, wherein the TA information is used for the terminal device to:
determine that the current TA supports the first network slice when the current TA of the terminal device is present in the first TAL; and/or
determine that the current TA does not support the first network slice when the current TA of the terminal device is absent in the first TAL.

17. The core network device of claim 15, wherein the instructions causing the core network device to transmit, to the terminal device, TA information corresponding to the first network slice cause the core network device to:
transmit a first non-access stratum (NAS) message to the terminal device, wherein the first NAS message contains the first TAL corresponding to the first network slice.

18. The core network device of claim 17, wherein the first NAS message contains rejected NSSAI, wherein the rejected NSSAI contains the first S-NSSAI and the first TAL corresponding to the first S-NSSAI.

19. The core network device of claim 17, wherein the instructions causing the core network device to transmit the first NAS message to the terminal device cause the core network device to:
transmit the first NAS message to the terminal device when the terminal device is in a first TA and the first TA does not support the first network slice.

20. The core network device of claim 15, wherein the one or more TAs comprise a TA in a current registration area (RA) of the terminal device.
